(19) United States
(12) Patent Application Publication
(10) Pub. No.: US 2013/0255871 A1
(43) Pub. Date: Oct. 3, 2013

(54) METHOD OF FORMING AN INJECTION PLASTIC PART WITH A COVERING

(71) Applicant: Jerome Clock, Hampton, IA (US)

(72) Inventor: Jerome Clock, Hampton, IA (US)

(73) Assignee: AERON LIFESTYLE TECHNOLOGY, INC., Fairfield, IA (US)

(21) Appl. No.: 13/433,958

(22) Filed: Mar. 29, 2012

(51) Int. Cl. B32B 37/24; B29C 70/68

(52) U.S. Cl. 156/221

(57) ABSTRACT

A method of forming an injection plastic part with a covering that includes adhering a layer of plastic to a covering. The layer of plastic and adhered to covering is then cut down and shaped into a predetermined mold and placed into an injection tool. Molten plastic is then injected into the tool in order to bond the covering to the injected plastic. After curing a product is provided with a covering bonded to the cured plastic.

### BACKGROUND OF THE INVENTION

This invention relates to making plastic parts. More specifically, this invention relates to a method of forming an injected plastic part with a covering.

Currently in the market are products that have parts that need to be made of a solid material yet have an exterior that is a covering to make the appearance of the product more aesthetically pleasing. Specifically, companies desire to put fabric, leather, wood veneer, and the like on a product to provide the product with a more aesthetically look. Still, attaching such a cover to a product can be difficult and time consuming especially when a product or part has multiple contours, is smaller in size, and the like.

Thus, a need exists in the art to provide a method of manufacturing a part that allows for placing such a covering onto a product part.

Therefore, a principal object of the present invention is to provide a method of forming an injected plastic part with a covering.

Another object of the present invention is to provide a method for forming an injected plastic part with a covering that is efficient and minimizes manufacturing times.

These and other objects, features, and advantages will become apparent from the specification and claims.

### BRIEF SUMMARY OF THE INVENTION

A method of forming an injected plastic part with a covering. A layer of plastic is adhered to a covering through a lamination process and then placed in a mold of a predetermined shape. Molten plastic is then injected into the mold and against the layer of plastic such as to heat the layer of plastic in order to bond with the injected molten plastic such that when the molten plastic cures it is formed with a covering secured thereto.

### BRIEF DESCRIPTION OF THE DRAWINGS

FIG. 1 is a schematic view of a lamination device; and

FIG. 2A is a side plan view of a heating device and vacuum chamber;

FIG. 2B is a side plan view of a vacuum chamber;

FIG. 2C is a side plan view of a vacuum chamber;

FIG. 2D is a side plan view of a cutting device;

FIG. 2E is a side plan view of a trimmed formed shape;

FIG. 2F is a side plan view of an injection mold; and

FIG. 3 is a schematic diagram of a molding system.

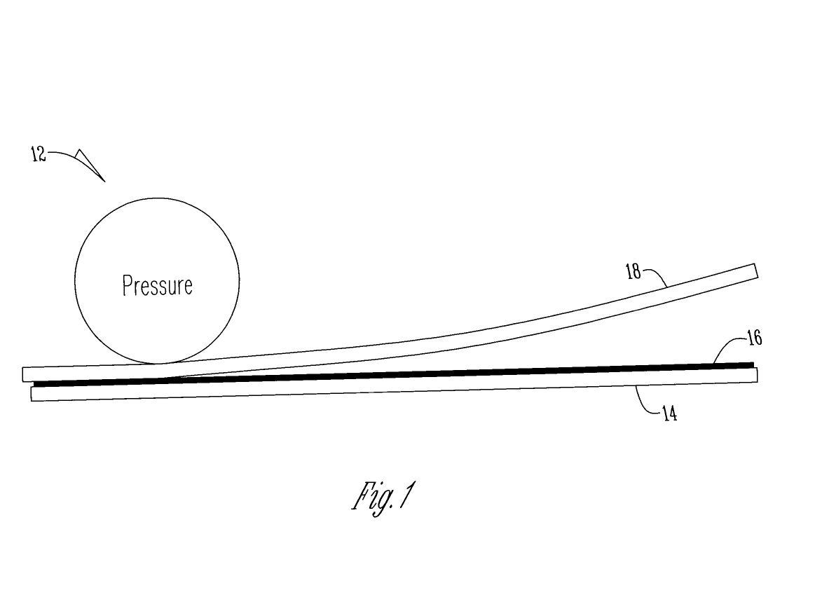

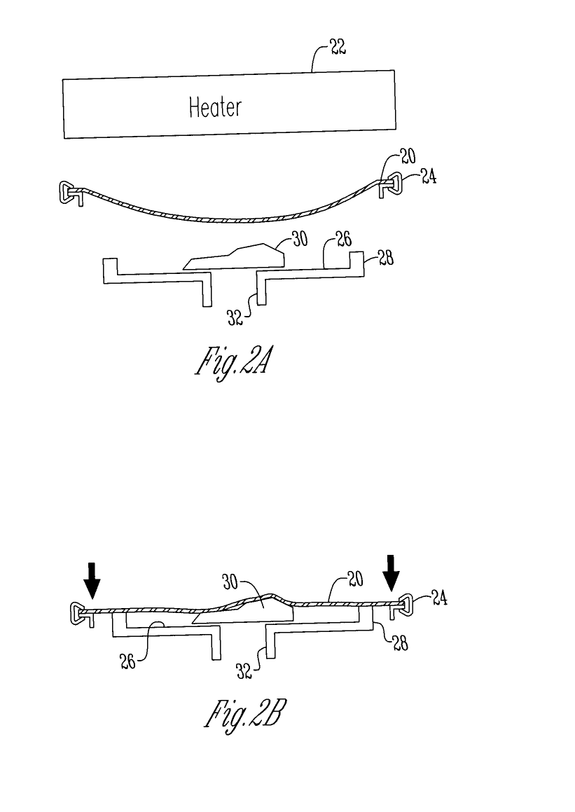

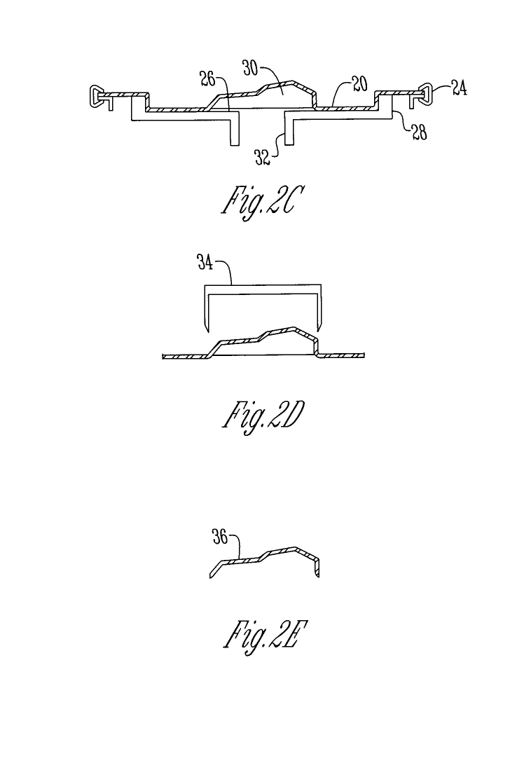

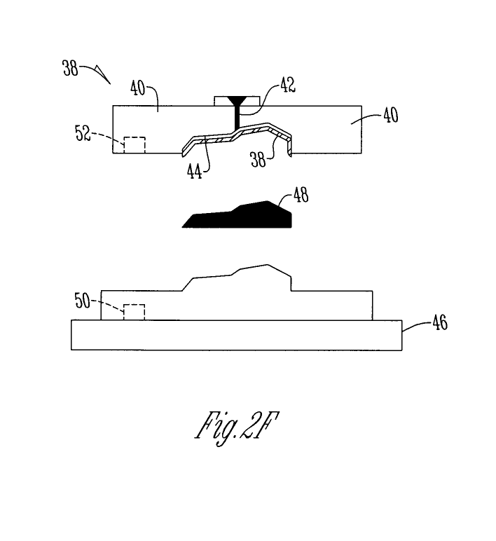

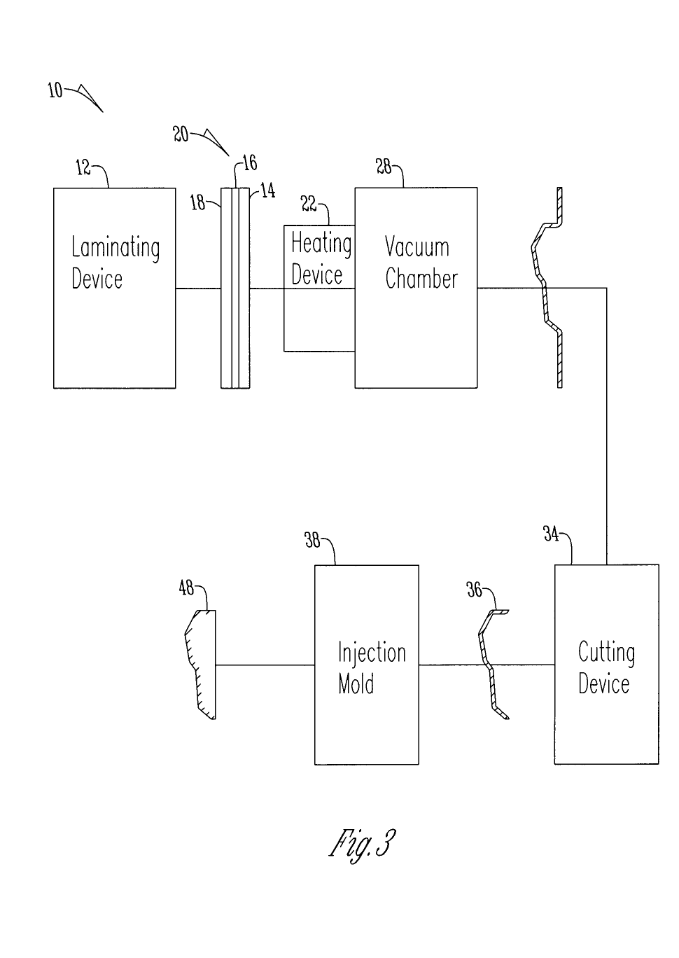

### DETAILED DESCRIPTION OF THE PREFERRED EMBODIMENT

The figures show a molding system 10 that includes a lamination device 12 used to laminate a layer of plastic 14 via a bonding agent 16 to a covering 18 to form a laminated fabric 20. The covering 18 can be any material that can provide an aesthetically pleasing look to a product such as fabric, leather, wood veneer, and the like. Once laminated a heating device 22 is utilized in to heat the laminated fabric 20. Clamping devices 24 are then used to secure the laminated fabric 20 within a cavity 26 of a vacuum chamber 28 over a part shape 30. The vacuum chamber 28 additionally has an opening 32 for receiving a vacuum. In this manner a vacuum force is used to pull the laminated fabric tightly against the part shape 30 and against the cavity 26 to form the laminated fabric to the shape of the part shape 30. At this time the laminated fabric 20 is cut with a cutting device 34 such as a cutting die to form a trimmed formed shape 36. The trimmed formed shape 36 is then placed into an injection mold 38.

The injection mold 38 has a first cavity plate 40 that receives injected plastic through at least one injection plastic opening 42 and has a mold cavity 44 that is the size and shape of the part shape 30. Specifically the trimmed formed shape 36 is inserted into and matingly received by the mold cavity 44 such that the trimmed formed shape 36 fits within the mold cavity 44 and either friction or static charge holds the trimmed formed shape 36 within the molded cavity 44.

A second cavity plate 46 is retractable and applies force to the first cavity plate 40 such that when plastic is injected in the mold cavity 44 the trimmed formed shape 36 bonds to the injected plastic such that when force is applied and the molten plastic becomes solid, the trimmed formed shape 36 is bonded to the molded tool to form a molded fabric part 48. Optionally the first or second cavity plate 40 or 46 can have guide stubs 50 and corresponding guide openings 52 to align the cavity plates 40 and 46. At this point the injection mold 38 is opened and the molded fabric part 48 is ejected.

In operation, after the layer of plastic 14 is laminated to the covering 18 the resulting laminated fabric 20 is heated and then vacuum molded to a part shape 30 and solidified to create a predetermined shape of an exterior of a product. The laminated fabric is then cut into a trimmed formed shape 36 that is placed into and held within the mold cavity 44 that has the shape of the trimmed formed shape 36. At this time the first and second cavity plates 40 and 46 are closed and molten plastic is injected into the injection mold 38. The molten plastic melts the thin layer of plastic 14 to bond the trimmed formed shape 36 to the plastic such that during the curing process when the plastic in the mold cavity 44 solidifies, the plastic of the trimmed formed shape 36 is bonded to the molded plastic part to form a molded fabric part 48. At this time the first and second cavities 40 and 46 are separated and the molded fabric part 48 is ejected from the mold cavity 44.

Thus provided is a system and method of forming an injected molded part with a covering 18. By utilizing the injected molded process in combination with a layer of plastic 14 that has been laminated to the covering 18 that is then shaped to the desired form, time is not wasted adhering the covering to a preexisting plastic product. In addition, the bond is significantly stronger and the manufacturing process of the part 48 is more efficient. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

1. A method of forming an injected plastic part with a covering steps comprising:
adhering a layer of plastic to a covering to form a laminated fabric;
shaping the laminated fabric into a predetermined shape;
cutting the laminated fabric in a predetermined shape to form a trimmed formed shape;
injecting molten plastic into an injection mold against the layer of plastic; and
curing the molten plastic to form a molded fabric part having the covering.

2. (canceled)

3. The method of claim 2 further comprising the step of holding the trimmed formed shape against an mold cavity of the injection mold before injecting the molten plastic into the mold cavity.

4. The method of claim 3 wherein the trimmed formed shape is held against the mold cavity with a static charge.

5. The method of claim 3 wherein the trimmed formed shape is held against the mold cavity with friction.

6. The method of claim 1 wherein the covering is selected from the group consisting of fabric, leather, and veneer.

7. The method of claim 1 wherein the laminated fabric is shaped into a predetermined shape within a vacuum chamber.
